(19) United States
(12) Patent Application Publication
(10) Pub. No.: US 2024/0272436 A1
(43) Pub. Date: Aug. 15, 2024

(54) IMAGE DISPLAY APPARATUS AND LIGHT GUIDE OPTICAL SYSTEM

(71) Applicant: SONY GROUP CORPORATION, Tokyo (JP)

(72) Inventor: Satoshi NAKANO, Tokyo (JP)

(73) Assignee: SONY GROUP CORPORATION, Tokyo (JP)

(21) Appl. No.: 18/562,489

(22) PCT Filed: Feb. 24, 2022
(86) PCT No.: PCT/JP2022/007473

§ 371 Date: Nov. 20, 2023

(30) Foreign Application Priority Data
May 28, 2021 (JP) 2021-090153

(51) Int. Cl. G02B 27/01; G02B 5/30; G02B 27/28

(52) U.S. Cl. CPC G02B 27/0172; G02B 5/3083; G02B 6/0088; G02B 27/283; G02B 2027/0174

(57) ABSTRACT

To achieve angle-of-view extension in an image display apparatus including a light guide plate. The present disclosure provides an image display apparatus including: a light guide plate; a polarization beam splitter unit arranged on a first surface of the light guide plate; and a polarization state converting unit arranged on a second surface of the light guide plate, in which the polarization state converting unit reflects image display light that has passed through the polarization beam splitter unit and entered the light guide plate and converts a polarization state of the image display light into a polarization state to be reflected by the polarization beam splitter unit at the time of reflection.

### TECHNICAL FIELD

The present disclosure relates to an image display apparatus and a light guide optical system. More specifically, the present disclosure relates to an image display apparatus configured to allow image display light to reach an eye through a light guide plate and a light guide optical system including such a light guide plate.

### BACKGROUND ART

In recent years, attention has been focused on a technology of displaying an image over an external landscape. Such a technology is also called augmented reality (AR) technology and a product using this technology can be an AR glass. The AR glass may include a light guide plate as a component for allowing image display light to reach a user's eye.

Various technologies related to the image display apparatus including the light guide plate have been proposed so far. For example, Patent Literature 1 below has disclosed an image display apparatus as a fifth embodiment which includes an illumination light source, a light guide prism integrated with an illumination prism as an illumination optical system, a first transmissive volume hologram optical element, and a reflective spatial light modulator (Paragraph 0076). Here, the illumination light source includes a semiconductor laser as its light source and is configured to guide a light flux emitted from the semiconductor laser to a light guide plate in a flat plate shape which is made of a synthetic resin. In this light guide plate, a light flux entering the light guide plate from one side edge is adjusted to have uniform illuminance and its emission angle is controlled, such that the light flux is emitted as illumination light from an emission surface that is a main surface of the light guide plate (Paragraph 0077).

### CITATION LIST

### Patent Literature

Patent Literature 1: Japanese Patent Application Laid-open No. 2003-337298

### DISCLOSURE OF INVENTION

### Technical Problem

An image display apparatus such as an AR glass desirably has lighter weight. For example, thinning a light guide plate for reducing the weight can achieve the lighter weight.

Such an image display apparatus also desirably has a wider angle-of-view. A light guide optical system can be configured so that image display light is extended on a surface in a light guide plate, which is perpendicular to a travelling direction of the image display light, in order to provide a wider angle-of-view.

However, in a case where the light guide plate is thinner, part of image display light can exit the light guide plate without reaching a user's eye because of the extended image display light, depending on a configuration of the light guide optical system. It is thus difficult to achieve both the apparatus weight reduction by thinning the light guide plate and the angle-of-view extension.

It is a primary objective of the present disclosure to achieve angle-of-view extension in an image display apparatus including a light guide plate. It is also one of objectives of the present disclosure to achieve weight reduction of such an image display apparatus.

### Solution to Problem

The present disclosure provides an image display apparatus including:
a light guide plate;
a polarization beam splitter unit arranged on a first surface of the light guide plate; and
a polarization state converting unit arranged on a second surface of the light guide plate, in which
the polarization state converting unit reflects image display light that has passed through the polarization beam splitter unit and entered the light guide plate and converts a polarization state of the image display light into a polarization state to be reflected by the polarization beam splitter unit at the time of reflection.

The image display apparatus may include an incidence unit that allows the image display light to enter the light guide plate, and
the incidence unit may reflect or transmit the image display light and allow the image display light to reach the polarization beam splitter unit.

The polarization beam splitter unit may be arranged between the incidence unit and the light guide plate.

The image display apparatus may include an emission unit that reflects and diffracts or transmits and diffracts the image display light and allows the image display light to be emitted from the light guide plate.

The emission unit may include a hologram lens element.

The emission unit may reflect and diffract or transmit and diffract the image display light so that the image display light concentrates.

The polarization beam splitter unit may selectively allow linearly polarized light or circularly polarized light to pass therethrough.

The polarization beam splitter unit may selectively allow linearly polarized light that is the image display light to pass therethrough, and
the polarization state converting unit may convert a polarization state of the linearly polarized light into the polarization state to be reflected by the polarization beam splitter unit when reflecting the linearly polarized light that has passed through the polarization beam splitter unit.

The polarization beam splitter unit may include a wire grid or a multi-layer dielectric film.

The polarization state converting unit may include a wave plate.

A phase control reflection film may be provided on a surface of two surfaces of the wave plate, which is on an air interface side.

The polarization beam splitter unit may have optical properties in that the polarization beam splitter unit selectively allows circularly polarized light that is the image display light to pass therethrough, and the polarization state converting unit may convert a polarization state of the circularly polarized light into the polarization state to be reflected by the polarization beam splitter unit when reflecting the circularly polarized light that has passed through the polarization beam splitter unit.

The polarization beam splitter unit may include a cholesteric liquid-crystal reflection element.

The second surface of the light guide plate may convert a polarization state of the circularly polarized light that has passed through the polarization beam splitter unit into the polarization state to be reflected by the polarization beam splitter unit.

The polarization state converting unit may include a phase control reflection film.

The phase control reflection film may be a silver coating.

The image display apparatus may further include a scanning mirror, and the scanning mirror may scan the image display light and allows the image display light to travel inside the light guide plate.

The image display apparatus may be configured so that image display light emitted from the light guide plate is concentrated in vicinity of a pupil and reaches a retina.

Moreover, the present disclosure also provides a light guide optical system including:
a light guide plate;
a polarization beam splitter unit arranged on a first surface of the light guide plate; and
a polarization state converting unit arranged on a second surface of the light guide plate, in which
the polarization state converting unit reflects image display light that has passed through the polarization beam splitter unit and entered the light guide plate and converts a polarization state of the image display light into a polarization state to be reflected by the polarization beam splitter unit at the time of reflection.

### BRIEF DESCRIPTION OF DRAWINGS

FIG. 1 A view showing a configuration example of a light guide optical system that allows image display light to enter a light guide plate through a prism.

FIG. 2 A view showing a schematic configuration example of an image display apparatus according to the present disclosure.

FIG. 3A A view showing a configuration example of the light guide optical system.

FIG. 3B A view showing a modified example of the light guide optical system.

FIG. 4 A view showing a configuration example of the light guide optical system.

FIG. 5 A view for describing optical properties of a cholesteric liquid-crystal reflection element.

FIG. 6 A view showing a configuration example of a laser light source unit.

FIG. 7 A diagram showing a configuration example of an image formation unit.

FIG. 8 A view showing a configuration example of the light guide optical system.

### MODE(S) FOR CARRYING OUT THE INVENTION

Hereinafter, favorable embodiments for carrying out the present disclosure will be described. It should be noted that the embodiments described below represent typical embodiments of the present disclosure and the scope of the present disclosure is not limited to these embodiments. It should be noted that descriptions of the present disclosure will be given in the following order.
1. Basic Concept of Present Disclosure
2. First Embodiment of Present Disclosure (Image Display Apparatus)
(1) Configuration Example of Light Guide Optical System in Case of Linearly Polarized Light
(2) Configuration Example of Light Guide Optical System in Case of Circularly Polarized Light
(3) Other Components
(4) Modified Examples Related to HOE
3. Second Embodiment of Present Disclosure (Light Guide Optical System)

### 1. Basic Concept of Present Disclosure

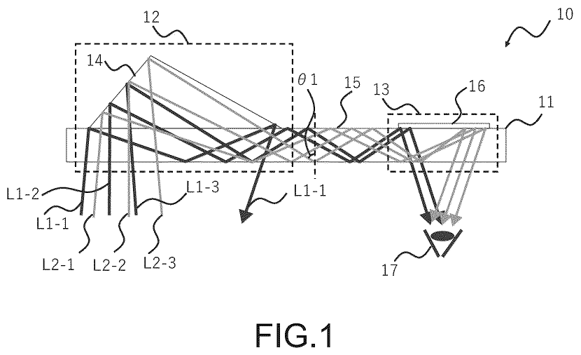

As to an image display apparatus including a light guide plate, image display light enters the light guide plate, travels inside the light guide plate while being reflected, and is emitted towards an eye from a predetermined position on the light guide plate. For example, an incidence unit including a prism and the like is provided for allowing the image display light to enter the light guide plate so that the image display light travels inside the light guide plate while being reflected. A configuration example of a light guide optical system that allows image display light to enter a light guide plate through a prism is shown in FIG. 1.

A light guide optical system 10 shown in FIG. 1 includes a light guide plate 11, an incidence unit 12 that allows image display light to enter the light guide plate 11, and an emission unit 13 that reflects and diffracts the image display light and allows the image display light to be emitted from the light guide plate 11.

The incidence unit 12 includes a prism 14. The prism 14 is arranged on a first surface 15 of the light guide plate 11. More specifically, the prism 14 is stacked on the first surface 15. The prism 14 reflects image display light and changes a travelling direction of the image display light into a direction in which the image display light can travel inside the light guide plate 11 while being reflected.

The image display light reflected by the prism 14 travels inside the light guide plate 11 while being reflected (in particular while being totally internally reflected).

The emission unit 13 includes a hologram lens element 16 and the hologram lens 16 reflects and diffracts image display light so as to allow the image display light to reach a user's eye 17. The reflected and diffracted image display light reaches the user's eye 17 as virtual image video light due to deflection and lens actions by the hologram lens element 16. For example, the image display light concentrating in the vicinity of a pupil of the eye 17 and reaching a retina achieves video presentation of so-called retinal projection type.

FIG. 1 shows three black arrows (also referred to as video light beams) L1-1 to L1-3 (also collectively referred to as L1) and three gray arrows L2-1 to L2-3 (also collectively referred to as L2), which represent image display light. The three black video light beams L1-1 to L1-3 are parallel to each other and represent light that defines one end of the angle-of-view. The three gray video light beams L2-1 to L2-3 are also parallel to each other and represent light that defines the other end of the angle-of-view.

As shown in FIG. 1, tracking the video light beams L1 and L2 in a direction opposite to the light travelling direction, the video light beams L1 and L2 gradually become wider towards an incidence unit 11 from the hologram lens element 16. In this manner, the video light beams travelling inside the light guide plate 11 has a spread.

A part of the video light beam L1 that has been reflected by the prism 14 and entered the light guide plate 11 can reenter the prism 14 without being reflected by the light guide plate 11 like the video light beam L1-1 in FIG. 1. The video light beam L1-1 that has reentered the prism 14 does not reach the user's eye 17 and it contributes to reduction in amount of light of a light flux in a video portion drawn by the video light beam L1. In order to avoid such reduction in amount of light, the angle-of-view is limited. It should be noted that the angle-of-view is defined by a range of video light beams that reach the hologram lens element 16.

Moreover, thinning the light guide plate can achieve weight reduction of the image display apparatus as described above. However, an angle of incidence θ1 when the image display light is reflected and travels inside the light guide plate has to be set to be larger because of thinning of the light guide plate. The increase in angle of incidence makes hologram element production more difficult. It is thus difficult to increase the angle-of-view especially in a case of employing a thin light guide plate.

An image display apparatus according to the present disclosure includes: a light guide plate; a polarization beam splitter unit arranged on a first surface of the light guide plate; and a polarization state converting unit arranged on a second surface of the light guide plate. Moreover, the polarization state converting unit reflects image display light that has passed through the polarization beam splitter unit and entered the light guide plate and converts a polarization state of the image display light into a polarization state to be reflected by the polarization beam splitter unit at the time of reflection. This can prevent reduction in amount of light of a light flux.

In an implementation of the present disclosure, the image display apparatus may be a retinal projection image display apparatus. A configuration for causing the image display light to reach an eye by the light guide plate is suitable especially in the retinal projection image display apparatus. In the present implementation, the image display apparatus may further include a scanning mirror that scans laser light for forming the video. The scanning mirror may be for example a micro electro mechanical systems (MEMS) mirror. The MEMS mirror may be commercially available one or may be one produced by any known technology in the related fields. The MEMS mirror is generally fabricated by micro-machining for a semiconductor process. The MEMS mirror scans light in such a manner that a micro-mirror with a size of about Φ1 mm resonates.

A projection object that the laser light scanned by the scanning mirror reaches may be a retina of an animal (in particular human) for example. In a case where the projection object is a retina, a hologram element for example can be used for projection to the retina.

In the present implementation, the image display apparatus may further include a hologram lens element that allows the laser light scanned by the scanning mirror to concentrate in the vicinity of a pupil and reach a retina. That is, the image display apparatus according to the present disclosure may be configured to allow the laser light scanned by the scanning mirror to concentrate in the vicinity of the pupil and reach the retina. The laser light concentrated in the vicinity of the pupil enables video presentation based on a so-called Maxwellian view.

In the present disclosure, the scanned laser light may be for example concentrated on the pupil or may be shift from the pupil in an optical-axis direction by about several millimeters (e.g., 1 mm to 10 mm and particularly 2 mm to 8 mm). The Maxwellian view can be achieved even in a case where the focal point is not on the pupil as in the latter case. Shifting the focal point in the optical-axis direction enables the user not to lose a video even if the video is shift. The above-mentioned diffracted light can be concentrated more particularly on a pupil, inside a crystalline lens, or in an area between a cornea portion surface and the pupil.

### 2. First Embodiment of Present Disclosure (Image Display Apparatus)

### (1) Configuration Example of Light Guide Optical System in Case of Linearly Polarized Light

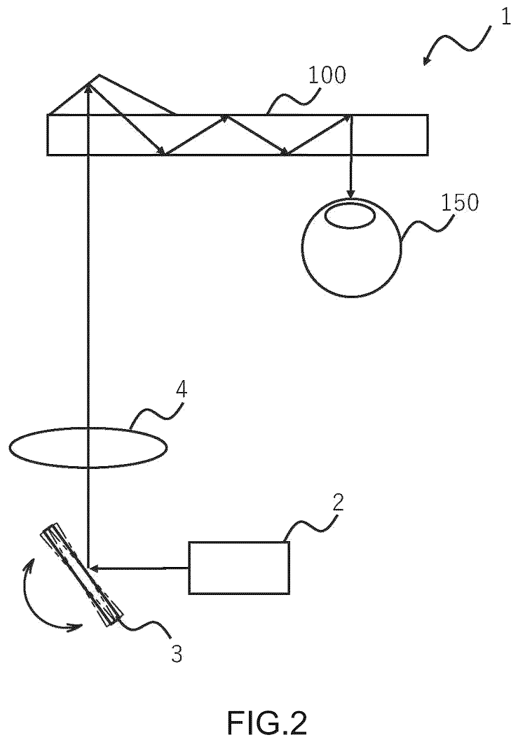

In accordance with an implementation of the present disclosure, the polarization beam splitter unit may be configured to selectively allow the linearly polarized light to pass therethrough. The present implementation will be described below with reference to FIG. 2.

FIG. 2 shows a schematic configuration example of an image display apparatus 1 according to the present disclosure. The image display apparatus 1 shown in the figure includes an image formation unit 2, a scanning mirror 3, a collimator lens 4, and a light guide optical system 100. In the figure, the arrows denote how image display light travels. It should be noted that the figure shows a schematic configuration example and does not show actual dimensions of the apparatus.

The image formation unit 2 emits image display light. The image display light reaches the scanning mirror 3. The scanning mirror 3 scans the image display light. The collimator lens 4 collimates the scanned image display light. Then, the collimated image display light reaches the light guide optical system 100. The light guide optical system 100 guides the image display light to an eye 150. The light guide optical system 100 (in particular an HOE to be described later) concentrates the image display light in the vicinity of a pupil of the eye 150 and allows the image display light to reach a retina of the eye 150. This achieves the video presentation of so-called retinal projection type.

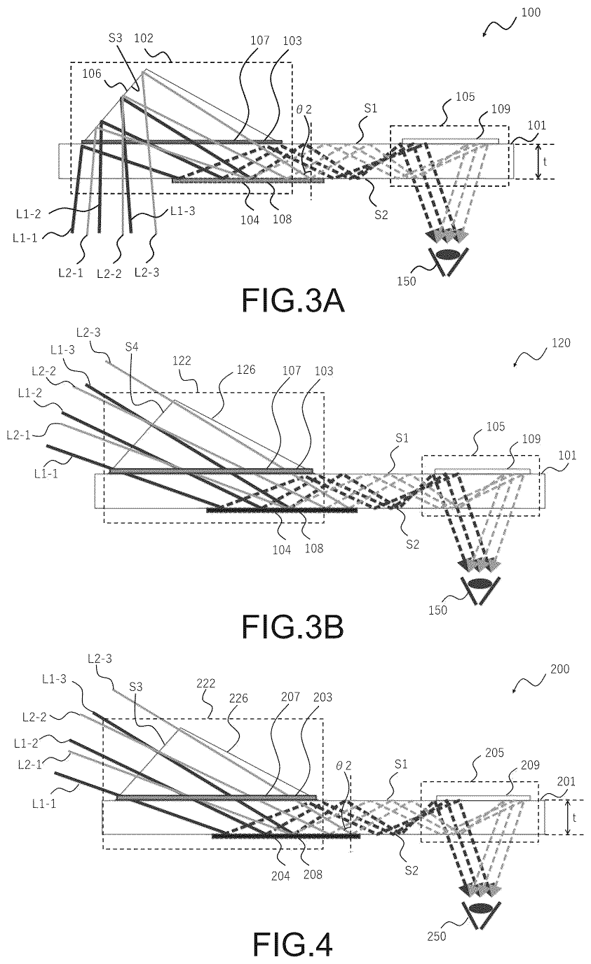

A configuration example of the light guide optical system 100 will be described with reference to FIG. 3A. The light guide optical system 100 includes a light guide plate 101, an incidence unit 102 that allows the image display light to enter the light guide plate 101, a polarization beam splitter unit 103, a polarization state converting unit 104, and an emission unit 105. Hereinafter, they will be described.

### (Light Guide Plate)

The light guide plate 101 reflects therein image display light that has traveled inside the light guide plate by the incidence unit 102 and guides the image display light to the emission unit 105. The light guide plate 101 may be formed from a material for a light guide plate known in the related fields or may be formed from a resin material or glass material for example. The resin material may be for example an acrylic based resin (e.g., PMMA or the like), a cyclo-olefin based resin (e.g., COP or the like), or a polycarbonate based resin.

The light guide plate 101 may have shape and size that can cover at least a part of a field-of-view of one eye for example. Alternatively, the light guide plate 101 may have for example shape and size similar to those of a lens of eyeglasses. The light guide plate 101 desirably has shape and size that can be supported by a frame used for eyeglasses. If the light guide plate 101 is too large or too thick, it imposes an excessive burden on a user who uses the image display apparatus.

A thickness t of the light guide plate 101 may be for example 10 mm or less, favorably 5 mm or less, more favorably 3 mm or less, much more favorably 2.8 mm or less, and especially favorably 2.5 mm or less for reducing the weight. The lower limit of the thickness of the light guide plate 101 may be set as appropriate. The lower limit of the thickness of the light guide plate 101 may be for example 0.1 mm or more, 0.2 mm or more, or 0.3 mm or more.

Moreover, the image display apparatus according to the present disclosure, an angle of incidence θ2 when the image display light is reflected inside the light guide plate 101 and travels to the emission unit may be for example 45 degrees or more. The angle of incidence may be for example 89 degrees or less, favorably 85 degrees or less, and more favorably 80 degrees or less.

The light guide plate 101 may allow external light to pass therethrough. Accordingly, the external light and the image display light reach the eye 150. That is, an image by the image display light is superimposed on the external landscape. Therefore, the image display apparatus can provide AR to the user. The light guide plate 101 may be for example transparent or semi-transparent.

### (Incidence Unit)

The incidence unit 102 allows the image display light to enter the light guide plate 101 and changes a travelling direction of the image display light so that the image display light travels to the emission unit 105 while being reflected inside the light guide plate 101. The incidence unit 102 may include a prism 106 as shown in FIG. 3A. In the figure, a surface S3 of the prism 106 reflects the image display light and this reflection changes the travelling direction of the image display light into a direction in which the image display light is totally internally reflected inside the light guide plate 101.

As shown in FIG. 3A, the incidence unit 102 reflects the image display light and allows the image display light to reach the polarization beam splitter unit 103.

Moreover, the incidence unit 102 may allow the image display light to pass therethrough and reach the polarization beam splitter unit 103. FIG. 3B shows an example of a light guide optical system including an incidence unit that allows the image display light to pass therethrough and reach the polarization beam splitter unit 103. A light guide optical system 120 shown in FIG. 3B is the same as the light guide optical system 100 shown in FIG. 3A except for the fact that an incidence unit 122 replaces the incidence unit 102. The incidence unit 122 shown in FIG. 3B includes a prism 126 as shown in the figure. The prism 126 allows image display light that has reached a surface S4 to pass therethrough and enter the prism. The image display light does not need to be refracted or may be refracted when the image display light passes through the prism 126. The image display light that has traveled inside the prism 126 reaches the polarization beam splitter unit 103.

As shown in FIG. 3A, the incidence unit 102 may be provided at an end portion of the light guide plate 101. For example, in a case where the image display apparatus has an eyeglasses-like shape, the incidence unit 102 may be provided at an end portion of the light guide plate 101 on a temple side of the eyeglasses (which corresponds to the lens of the eyeglasses).

### (Polarization Beam Splitter Unit)

The polarization beam splitter unit 103 selectively transmits or reflects image display light depending on a polarization state of the image display light. The polarization beam splitter unit 103 may be arranged between the incidence unit 102 and the light guide plate 101. For example, the polarization beam splitter unit 103 is arranged for preventing image display light reflected by the polarization state converting unit 104 to be described later from entering the incidence unit.

In an implementation of the present disclosure, the image display light may be linearly polarized light. That is, the polarization beam splitter unit 103 may include an optical element that selectively transmits or reflects the image display light depending on whether the image display light is P-polarized light or S-polarized light. The optical element may have a film or sheet shape. The optical element may be for example a wire grid or a multi-layer dielectric film.

For example, the optical element may have optical properties in that the optical element transmits linearly polarized light that is one of the P-polarized light and the S-polarized light and reflects the other. More specifically, the optical element may have optical properties in that the optical element transmits the P-polarized light and reflects the S-polarized light or may have optical properties in that the optical element transmits the S-polarized light and reflects the P-polarized light. Which one of the optical properties the optical element has may be selected depending on a polarization state of the image display light and a configuration of the polarization state converting unit.

For example, in a case where the image display light that travels to the polarization beam splitter unit 103 from the incidence unit 102 is the P-polarized light, the polarization beam splitter unit 103 is configured to have optical properties in that the polarization beam splitter unit 103 transmits the P-polarized light and reflects the S-polarized light.

Moreover, in a case where the image display light that travels to the polarization beam splitter unit 103 from the incidence unit 102 is the S-polarized light, the polarization beam splitter unit 103 is configured to have optical properties in that the polarization beam splitter unit 103 transmits the S-polarized light and reflects the P-polarized light.

The polarization beam splitter unit 103 may include the polarization beam splitter (PBS) or may include a laminate of the polarization beam splitter and a phase control reflection film.

FIG. 3A shows a state in which the polarization beam splitter unit 103 is constituted only by a polarization beam splitter 107. The polarization beam splitter 107 may be stacked on a first surface S1 of the light guide plate 101. That is, the light guide plate 101, the polarization beam splitter unit 107, and the prism 106 are stacked in the stated order.

The image display light reflected by the surface S3 of the prism 106 reaches the polarization beam splitter 107. In a case where the image display light reflected by the surface S3 of the prism 106 is the P-polarized light, the polarization beam splitter 107 has optical properties in that the polarization beam splitter 107 transmits the P-polarized light and reflects the S-polarized light. With these optical properties, the polarization beam splitter 107 transmits the image display light reflected by the surface S3 of the prism 106.

In a case where the image display light reflected by the surface S3 of the prism 106 is the P-polarized light, the polarization state converting unit 104 to be described later reflects the image display light and converts the polarization state of the image display light from the P-polarized light to the S-polarized light. The image display light converted into the S-polarized light reaches the polarization beam splitter 107 again. The polarization beam splitter 107 has the optical properties as described above. Therefore, the polarization beam splitter 107 reflects the image display light converted into the S-polarized light. This can prevent the image display light reflected by the polarization state converting unit 104 from reentering the prism 106.

Since the light guide optical system 10 in FIG. 1 includes no polarization beam splitter unit, the light L1-1 reenters the prism and does not reach the user's eye. As a result, the amount of light lowers. On the other hand, the light guide optical system 100 shown in FIG. 3A can prevent reduction in amount of light owing to the polarization beam splitter unit 103 and the polarization state converting unit 104.

### (Polarization State Converting Unit)

The polarization state converting unit 104 reflects image display light that has passed through the polarization beam splitter unit 103 and entered the light guide plate 101 and converts a polarization state of the image display light into a polarization state to be reflected by the polarization beam splitter unit 103 at the time of reflection.

Here, as described above, the image display light may be the linearly polarized light. That is, the polarization state converting unit 104 includes an optical element that converts the S-polarized light into the P-polarized light or converts the P-polarized light into the S-polarized light at the time of reflection of the image display light. The optical element may have a film or sheet shape for example. The polarization state converting unit 104 includes for example a wave plate and in particular a quarter wave plate (hereinafter, also referred to as QWP) as the optical element.

For example, the optical element may have optical properties in that the optical element converts the S-polarized light into the P-polarized light or may have optical properties in that the optical element converts the P-polarized light into the S-polarized light. Which one of the optical properties the optical element has can be selected depending on a polarization state of the image display light that reaches the polarization state converting unit 104.

For example, in a case where the image display light that has passed through the polarization beam splitter unit 103 and reached the polarization state converting unit 104 is the P-polarized light, the polarization state converting unit 104 is configured to have optical properties in that the polarization state converting unit 104 converts the P-polarized light into the S-polarized light.

Moreover, in a case where the image display light that has passed through the polarization beam splitter unit 103 and reached the polarization state converting unit 104 is the S-polarized light, the polarization state converting unit 104 is configured to have optical properties in that the polarization state converting unit 104 converts the S-polarized light into the P-polarized light.

With the optical properties as described above, the image display light reflected by the polarization state converting unit 104 is reflected by the polarization beam splitter unit 103. This can prevent reduction in amount of light.

The polarization state converting unit 104 may be the QWP 108 arranged on a second surface S2 of the light guide plate 101 as shown in FIG. 3A. For example, as shown in FIG. 3A, the polarization state converting unit 104 (e.g., the QWP 108) may be stacked on the second surface S2. The image display light that has passed through the polarization beam splitter 107 and traveled inside the light guide plate 101 reaches the QWP 108.

In a case where the image display light that has traveled inside the light guide plate 101 is the P-polarized light, the QWP 108 has optical properties in that the QWP 108 converts the P-polarized light into the S-polarized light. With these optical properties, the QWP 108 converts the polarization state of the image display light that has traveled inside the light guide plate 101 into the S-polarized light and reflects the image display light. The image display light converted into the S-polarized light reaches the polarization beam splitter 107 again.

The polarization beam splitter 107 has the optical properties as described above. Therefore, the polarization beam splitter 107 reflects the image display light converted into the S-polarized light. This can prevent the image display light reflected by the QWP 108 from reentering the prism 106.

The polarization state converting unit 104 may further include a phase control reflection film. For example, the QWP 108 has two surfaces, which are a contact surface with the second surface S2 of the light guide plate 101 and a surface opposite to the contact surface, and the phase control reflection film may be stacked on the opposite surface. That is, a laminate structure in which the QWP 108 and the phase control reflection film are stacked in the stated order may be formed on the second surface S2 of the light guide plate 101.

At the time of total internal reflection of the QWP 108, a phase difference between a P-polarized light component and an S-polarized light component can be generated. The phase control reflection film can suppress the phase difference generation. It should be noted that the phase difference generated by the QWP may be adjusted so as to overcome the phase difference generated at the time of total internal reflection.

The phase control reflection film may be a reflective film coating formed from a metal material for example or may be in particular a silver reflective film coating. The silver coating is especially favorably used as the reflective film coating.

### (Emission Unit)

The emission unit 105 allows the image display light to be emitted from the light guide plate 101 and reach the eye 150. For example, the emission unit 105 reflects and diffracts the image display light and allows the image display light to be emitted from the light guide plate 101. The emission unit 105 may reflect and diffract the image display light so that the image display light concentrates. The emission unit 105 includes a holographic optical element (HOE) 109. The holographic optical element 109 may be in particular a hologram lens element, and in particular a volume hologram lens. The holographic optical element (in particular the volume hologram lens) may be formed from photo polymers.

The HOE 109 may have optical properties in that the HOE 109 selectively diffracts the image display light. For example, the holographic optical element 109 may diffract light having a particular wavelength and having a particular angle of incidence so that the light concentrates in the vicinity of the pupil.

The HOE 109 may be provided on the first surface S1 (surface further from the user's eye 150) or may be provided on the second surface S2 (surface closer to the user's eye 150) out of the two surfaces of the light guide plate 101 as shown in FIG. 3A.

As shown in the figure, the HOE 109 reflects and diffracts the image display light that has reflected inside the light guide plate 101 and reached the HOE 109. The HOE 109 configured as a reflective diffraction element may be provided on the first surface S1 or may be provided on the second surface S2. Moreover, in either a case where the HOE 109 configured as the reflective diffraction element is provided on the first surface S1 or a case where the HOE 109 is provided on the second surface S2, the eye 150 may be arranged at a position shown in FIG. 3A or a position opposite to the position of the eye 150 shown in FIG. 3A through the light guide plate 101. That is, in a case where the HOE 109 configured as the reflective diffraction element is employed, the relationship position between the HOE 109 and the eye 150 may be any one of four patterns that are two patterns (surface S1 and surface S2)×two patterns (surface S1 side and surface S2 side).

It should be noted that the HOE 109 may be configured to transmit and diffract the image display light that has reflected inside the light guide plate 101 and reached the HOE 109. The HOE 109 configured as a transmissive diffraction element may be provided on the second surface S2 or may be provided on the first surface S1. In either a case where the HOE 109 configured as the transmissive diffraction element is provided on the first surface S1 or a case where it is provided on the second surface S2, the eye 150 may be a position shown in FIG. 3A or may be arranged at a position opposite to the position of the eye 150 shown in FIG. 3A through the light guide plate 101. That is, also in a case where the HOE 109 configured as the transmissive diffraction element is employed, the relationship position between the HOE 109 and the eye 150 may be any one of four patterns that are two patterns (surface S1 and surface S2)×two patterns (surface S1 side and surface S2 side).

It should be noted that in a case where the reflective diffraction element is arranged on the surface S1 side and the eye is located on the surface S1 side, the reflective diffraction element is configured to reflect and diffract light immediately after the light is totally internally reflected by the surface S1, and such a diffraction element can be designed. Moreover, the same applies to a case where the transmissive diffraction element is used.

The HOE 109 reflects and diffracts or transmits and diffracts the image display light so that the image display light is concentrated in the vicinity of the pupil of the eye 150 for example and reaches the retina. This achieves the video presentation of so-called retinal projection type and a video can be presented to the user in a so-called Maxwellian view.

### (Travel of Light)

FIG. 3A shows three black arrows (also referred to as video light beams) L1-1 to L1-3 (also collectively referred to as L1) and three gray arrows L2-1 to L2-3 (also collectively referred to as L2), which represent image display light. The three black video light beams L1-1 to L1-3 are parallel to each other and represent light that defines one end of the angle-of-view. The three gray video light beams L2-1 to L2-3 are also parallel to each other and represent light that defines the other end of the angle-of-view. Moreover, the solid-line arrows denote the P-polarized light and the broken-line arrows denote the S-polarized light.

As shown in FIG. 3A, the video light beams L1 and L2 reflected by the surface S3 of the prism 106 are the P-polarized light. The video light beams L1 and L2 reflected by the surface S3 of the prism 106 reach the polarization beam splitter unit 103. The polarization beam splitter unit 103 has optical properties in that the polarization beam splitter unit 103 transmits the P-polarized light. Therefore, the polarization beam splitter unit 103 transmits the video light beams L1 and L2.

The video light beams L1 and L2 that have passed through the polarization beam splitter unit 103 reach the polarization state converting unit 104. The polarization state converting unit 104 has optical properties in that the polarization state converting unit 104 reflects the image display light that is the P-polarized light and converts its polarization state into the S-polarized light. Therefore, the polarization state converting unit 104 reflects the video light beams L1 and L2 and converts its polarization state into the S-polarized light at the time of reflection.

L1-1 that is a part of the video light beams L1 and L2 converted into the S-polarized light reaches the polarization beam splitter unit 103 again. The polarization beam splitter unit 103 has optical properties in that the polarization beam splitter unit 103 reflects the S-polarized light. Therefore, L1-1 does not travel inside the prism 106, is reflected by the polarization beam splitter unit 103 and then reflected inside the light guide plate 101, and travels to the emission unit 105.

The other video light beams L1-2 to L1-3 and L2-1 to L2-3 are reflected inside the light guide plate 101 and travel to the emission unit 105.

In this manner, all the video light beams L1-1 to L1-3 and L2-1 to L2-3 travel to the emission unit 105 while being reflected.

As described above, in accordance with the present disclosure, the particular polarization beam splitter unit and polarization state converting unit are respectively arranged on the two surfaces of the light guide plate, which can prevent reduction in amount of light of a light flux. Accordingly, the angle-of-view can also be increased. In addition, the angle-of-view can also be increased in a case where the light guide plate is thinner.

### (2) Configuration Example of Light Guide Optical System in Case of Circularly Polarized Light

In accordance with an implementation of the present disclosure, the polarization beam splitter unit may be configured to selectively allow the circularly polarized light to pass therethrough. The present implementation will be described below with reference to FIG. 4.

FIG. 4 shows a configuration example of a light guide optical system 200 included in the image display apparatus according to the present disclosure. The light guide optical system 200 includes a light guide plate 201, an incidence unit 222 that allows image display light to enter the light guide plate 201, a polarization beam splitter unit 203, a polarization state converting unit 204, and an emission unit 205. Hereinafter, they will be described. The light guide plate 201, the incidence unit 222, and the emission unit 205 are the same as the light guide plate 101, the incidence unit 122, and the emission unit 105 which have been described above in (1), and the descriptions related to them can be applied to the present implementation. Hereinafter, the polarization beam splitter unit 203 and the polarization state converting unit 204 will be described.

### (Polarization Beam Splitter Unit)

The polarization beam splitter unit 203 selectively transmits or reflects the image display light depending on a polarization state of the image display light.

In an implementation of the present disclosure, the image display light may be the circularly polarized light. That is, the polarization beam splitter unit 203 may include an optical element that selectively transmits or reflects the image display light depending on whether the image display light is left-circularly polarized light (hereinafter, also referred to as LCP) or right-circularly polarized light (hereinafter, also referred to as RCP). The optical element may be for example a cholesteric liquid-crystal (CLC) reflection element.

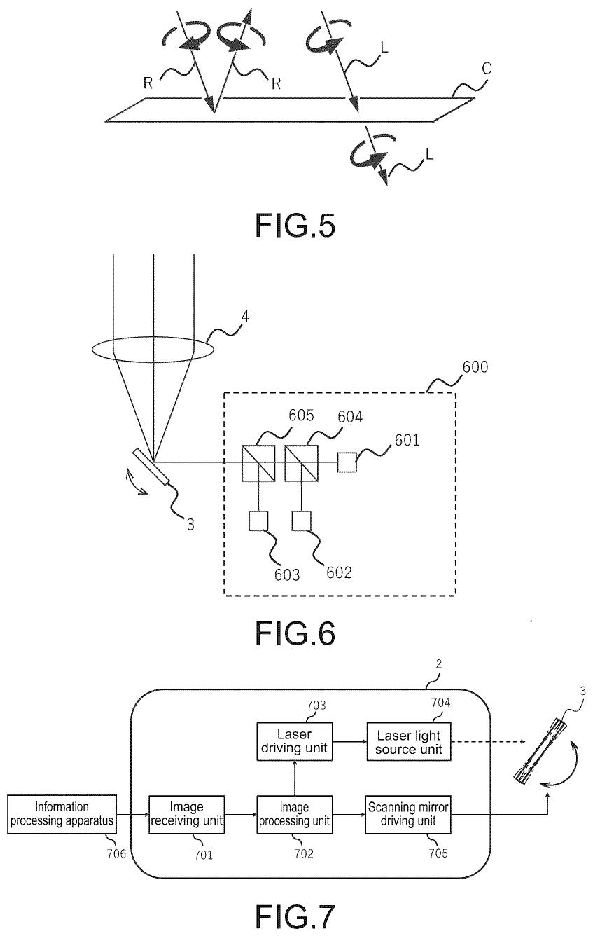

For example, as shown in FIG. 5, a cholesteric liquid-crystal reflection element C has optical properties in that the cholesteric liquid-crystal reflection element C reflects right-circularly polarized light R and transmits left-circularly polarized light L. In contrast, the cholesteric liquid-crystal reflection element may have optical properties in that the cholesteric liquid-crystal reflection element reflects the left-circularly polarized light and transmits the right-circularly polarized light.

The cholesteric liquid-crystal reflection element may be a film or sheet-like material formed from a cholesteric liquid-crystal material. As to liquid-crystal molecules that constitute the cholesteric liquid-crystal material, the long axes of the liquid-crystal molecules are aligned in a particular direction in each of layers and the long axes of the liquid-crystal molecules in one layer of adjacent layers are rotated with respect to the other layer, which gives a spiral structure. Such a structure is also called chiral structure for example. This structure provides circularly polarized light selectivity.

For example, the optical element may have optical properties in that the optical element transmits the LCP and reflects the RCP or may have optical properties in that the optical element transmits the RCP and reflects the LCP. Which one of the optical properties the optical element has can be selected depending on a polarization state of the image display light or a configuration of the polarization state converting unit. For example, in a case where the image display light that travels to the polarization beam splitter unit 203 from an incidence unit 202 is the LCP, the polarization beam splitter unit 203 is configured to have optical properties in that the polarization beam splitter unit 203 transmits the LCP and reflects the RCP. Moreover, in a case where the image display light that travels to the polarization beam splitter unit 203 from the incidence unit 202 is the RCP, the polarization beam splitter unit 203 is configured to have optical properties in that the polarization beam splitter unit 203 transmits the RCP and reflects the LCP.

The polarization beam splitter unit 203 may be a cholesteric liquid-crystal reflection element 207 arranged between the light guide plate 201 and a prism 226 as shown in FIG. 4. The image display light that has passed through a surface S3 of the prism 226 reaches the cholesteric liquid-crystal reflection element 207.

In a case where the image display light that has passed through the surface S3 of the prism 206 is the LCP, the cholesteric liquid-crystal reflection element 207 has optical properties in that the cholesteric liquid-crystal reflection element 207 transmits the LCP and reflects the RCP. With these optical properties, the cholesteric liquid-crystal reflection element 207 transmits the image display light reflected by the surface S3 of the prism 206. Moreover, in a case where the image display light that has passed through the surface S3 of the prism 206 is the RCP, the polarization state converting unit 204 to be described later reflects the image display light and converts the polarization state of the image display light into the LCP from the RCP. The image display light converted into the LCP reaches the cholesteric liquid-crystal reflection element 207 again.

The cholesteric liquid-crystal reflection element 207 has the optical properties as described above. Therefore, the cholesteric liquid-crystal reflection element 207 reflects the image display light converted into the LCP. This can prevent the image display light reflected by the polarization state converting unit 204 from reentering the prism 206.

### (Polarization State Converting Unit)

The polarization state converting unit 204 reflects image display light that has passed through the polarization beam splitter unit 203 and entered the light guide plate 201 and converts a polarization state of the image display light into a polarization state to be reflected by the polarization beam splitter unit 203 at the time of reflection.

As described above, the image display light may be the circularly polarized light. That is, the polarization state converting unit 204 converts the LCP into the RCP or converts the RCP into the LCP at the time of reflection of the image display light. The polarization state converting unit 204 may be the second surface S2 of the light guide plate 201 for example. The reflection on the second surface S2 of the light guide plate 201 converts the polarization state.

The polarization state converting unit 204 may further include a phase control reflection film 208 as shown in FIG. 4. The phase control reflection film 208 is provided on the second surface S2 of the light guide plate 201 for example. That is, a laminate structure of the light guide plate 201 and the phase control reflection film 208 is formed. The phase control reflection film 208 may be a reflective film coating formed from a metal material for example or may be in particular a silver reflective film coating. The silver coating is especially favorably as the reflective film coating. The phase control reflection film 208 can reduce a phase difference change between the RCP and the LCP of the image display light entering and reflected. Accordingly, it can be converted into the RCP (or LCP) while keeping the ellipticity of the entering LCP (or RCP) nearly 1.

### (3) Other Components

The image formation unit 2 may include a laser light source unit including a plurality of laser light sources and a group of one or more optical elements for combining laser light emitted from the plurality of laser light sources.

The laser light source unit may be configured to emit laser light obtained by combining laser light of a plurality of color light beams or may be configured to emit mono-color laser light. In the former case, the combined light beam is reflected by the scanning mirror and travels to the light guide plate. In the former case, the number of laser light sources included in the laser light source unit may be for example 2 to 5 and particularly 2, 3, or 4.

A configuration example of such a laser light source unit will be described hereinafter with reference to FIG. 6. It should be noted that in the figure, light beams emitted from the laser light sources are shown as a single line with no spread. As shown in the figure, a laser light source unit 600 includes three laser light sources 601, 602, and 603. These laser light sources are configured to emit laser light in R (red), G (green), and B (blue), respectively.

The laser light source unit 600 includes for example dichroic mirrors 604 and 605 as a group of optical elements for combining a plurality of laser light beams emitted from the laser light sources 601 to 603.

The dichroic mirror 604 has optical properties in that the dichroic mirror 604 transmits laser light emitted from the laser light source 601 and reflects laser light emitted from the laser light source 602. Accordingly, laser light emitted from the laser light source 601 and 602 are combined.

The dichroic mirror 605 has optical properties in that the dichroic mirror 605 transmits laser light emitted from the laser light sources 601 and 602 and reflects laser light emitted from the laser light source 603. Accordingly, the laser light emitted from the laser light sources 601 and 602 and the laser light emitted from the laser light source 603 are combined.

As described above, the laser light source unit 600 emits the light beam obtained by combining the three laser light beams. These light beams reach the scanning mirror 3.

The laser light source unit 600 may be configured to emit laser light that is the linearly polarized light (P-polarized light or S-polarized light) or the circularly polarized light (right-circularly polarized light or left-circularly polarized light) as the light beam that travels to the scanning mirror 3. The laser light source unit 600 may include for example a polarization element for emitting laser light in a predetermined polarization state. A laser light source with the polarization element generates laser light having a predetermined polarization state. Moreover, the polarization element may be arranged at any position on the optical path from the laser light source unit 600 to the light guide optical system 200.

The image formation unit 2 may include a component other than the laser light source unit. A configuration example of the image formation unit 2 will be described with reference to a block diagram shown in FIG. 7. The image formation unit 2 may include an image receiving unit 701, an image processing unit 702, a laser driving unit 703, a laser light source unit 704, and a scanning mirror driving unit 705 and may be for example configured as a drawing system including them.

The image receiving unit 701 receives image signals sent from an information processing apparatus 706 and then sends the image signals to an image processing unit 112. The information processing apparatus may be an apparatus configured separately from the image display apparatus. The information processing apparatus may be for example a computer, a cloud system, or the like. Alternatively, the information processing apparatus may be included in the image display apparatus.

The image receiving unit 701 may be an image receiver or may be more particularly a digital receiver or an analog receiver. The digital receiver may be a digital receiver according to standards such as DVI (registered trademark), HDMI (registered trademark), or DisplayPort for example. The analog receiver may be for example an analog RGB receiver.

The image processing unit 702 receives image signals sent from the image receiving unit 701, and then controls the image display apparatus on the basis of the image signals. For example, the image processing unit controls the scanning mirror drive unit and the laser drive unit on the basis of the image signals. Accordingly, video presentation by laser light is performed. The image processing unit may include for example a micro-processor, a system-on-a-chip (SoC), or a field-programmable gate array (FPGA).

The laser driving unit 703 may include the D/A converter that converts a digital signal output from the image processing unit into an analog signal.

The laser light source unit 704 is as described above and may have a configuration described above with reference to FIG. 6 for example.

The scanning mirror driving unit 705 may include a D/A converter that converts the digital signal output from the image processing unit into an analog signal. The scanning mirror drive unit may further include an operational amplifier that amplifies the output signal generated by this conversion to a driving voltage level for the scanning mirror 3.

The image formation unit 2 may further include an image storage unit (not shown). Signals are written and/or read for processing the image signals output from the image receiving unit. The image storage unit may include for example a SRAM or a DRAM, and may include in particular an SDRAM, a DDR SDRAM, or the like.

The scanning mirror 3 scans scanning laser light emitted from the image formation unit 2. The scanning mirror 3 scans the image display light and allows it to travel inside the light guide plate 101. This scan allows formation of an image. The scanning mirror 3 may be for example a micro electro mechanical systems (MEMS) mirror. The MEMS mirror may be commercially available one or may be one produced by any known technology in the related fields. The MEMS mirror is generally fabricated by micro-machining for a semiconductor process. The MEMS mirror scans light in such a manner that a micro-mirror with a size of about Φ1 mm resonates.

The scanning mirror 3 may be a scanning mirror operable in two-axis directions or may be a combination of two scanning mirrors capable of scanning in a one-axis direction. Accordingly, a two-dimensional image can be projected. As to the scanning mirror 3, the two axes in the former case and the scanning axes of the two scanning mirrors in the latter case may be orthogonal to each other. A desired image is generated by modulating the intensity of laser light emitted from the laser light source group in synchronization with scanning of the scanning mirror.

The scanning mirror 3 may be either a capacitive scanning mirror or an electromagnetically-driven scanning mirror. With either technique, the scanning mirror is driven in a resonance axis direction and a non-resonance axis direction perpendicular to the resonance axis direction. Scanning of the non-resonance axis direction is performed by applying a voltage on the scanning mirror. The scanning mirror 3 is driven by the scanning mirror drive unit that outputs driving signals for driving the scanning mirror 3.

Light beams scanned by the scanning mirror 3 reach the collimator lens 4 at different angles. The collimator lens 4 converts these light beams to be optical paths parallel to each other. The light beams made parallel by the collimator lens 4 reach the light guide optical system 100.

The image display apparatus 1 may further include various components used for image projection, such as a disk, a communication device, and a drive for example. This disk may store various programs and various types of video data such as a program for image projection by the image display apparatus 1 for example. The communication device may acquire a program and/or video data for controlling the image display apparatus 1 from a network for example. The drive may read a program and/or video data recorded on a recording medium such as a micro SD memory card and an SD memory card for example and output the program and/or video data to the RAM.

The image display apparatus 1 may be configured as for example a head-mounted display (hereinafter, also referred to as HMD). The head-mounted display may be for example a transmissive HMD or may be a non-transmissive HMD.

The transmissive HMD may be configured as an eyeglasses-type display for example. In this case, the HOE 109 may allow light from an external landscape to pass therethrough and reach an eye. The HOE 109 may be provided in a portion corresponding to a lens of eyeglasses. The transmissive HMD can superimpose a video presented by the image display apparatus 1 on the external landscape and provide for example AR to the user.

The non-transmissive HMD may be for example one completely covering both eyes. In this case, no light from the external landscape reaches the eyes.

### (4) Modified Examples Related to HOE

In the present disclosure, the number of emission units provided on the light guide plate is not limited to one, and may be two or more. For example, two or more HOEs may be provided at different positions on the light guide plate. This can extend the area where a video by image display light emitted from the light guide plate can be visually recognized.

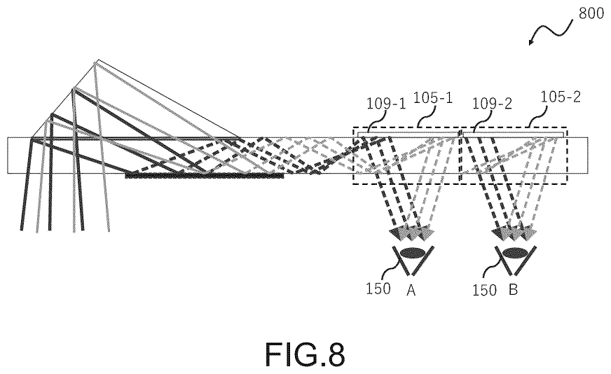

A configuration example related to the light guide plate on which the two or more HOEs are arranged will be described with reference to FIG. 8. A light guide optical system 800 shown in the figure is the same as the light guide optical system 100 described with reference to FIG. 3A except for the fact that two emission units 105-1 and 105-2 are provided.

HOEs 109-1 and 109-2 are respectively provided in the emission units 105-1 and 105-2. Accordingly, the video can be visually recognized also in a case where the position of the eye 150 with respect to the light guide plate 101 is either a position A or position B.

### 3. Second Embodiment of Present Disclosure (Light Guide Optical System)

The present disclosure also provides a light guide optical system including: a light guide plate; a polarization beam splitter unit arranged on a first surface of the light guide plate; and a polarization state converting unit arranged on a second surface of the light guide plate. Here, the polarization state converting unit may be configured to reflect image display light that has passed through the polarization beam splitter unit and entered the light guide plate and convert a polarization state of the image display light into a polarization state to be reflected by the polarization beam splitter unit at the time of reflection. The light guide optical system can achieve angle-of-view extension as described above in “1.” and “2.” In addition, the light guide optical system can reduce the thickness of the light guide plate. Therefore, it can also reduce the weight of the light guide optical system.

The light guide optical system may have the configuration as described above “1.” and “2.” and these descriptions can also be applied to the present embodiment. Moreover, the light guide optical system is suitable for the use in for example an image display apparatus and in particular a retinal projection image display apparatus. The image display apparatus may further include a scanning mirror that performs scanning laser light for forming the video for example. The image display apparatus may have the configuration as described above “1.” and “2.” for example.

It should be noted that the present disclosure can also take the following configurations.

[1] An image display apparatus, including:
a light guide plate;
a polarization beam splitter unit arranged on a first surface of the light guide plate; and
a polarization state converting unit arranged on a second surface of the light guide plate, in which
the polarization state converting unit reflects image display light that has passed through the polarization beam splitter unit and entered the light guide plate and converts a polarization state of the image display light into a polarization state to be reflected by the polarization beam splitter unit at the time of reflection.

[2] The image display apparatus according to [1], in which
the image display apparatus includes an incidence unit that allows the image display light to enter the light guide plate, and
the incidence unit reflects or transmits the image display light and allows the image display light to reach the polarization beam splitter unit.

[3] The image display apparatus according to [2], in which
the polarization beam splitter unit is arranged between the incidence unit and the light guide plate.

[4] The image display apparatus according to any one of [1] to [3], in which
the image display apparatus includes an emission unit that reflects and diffracts or transmits and diffracts the image display light and allows the image display light to be emitted from the light guide plate.

[5] The image display apparatus according to [4], in which
the emission unit includes a hologram lens element.

[6] The image display apparatus according to [4] or [5], in which
the emission unit reflects and diffracts or transmits and diffracts the image display light so that the image display light concentrates.

[7] The image display apparatus according to any one of [1] to [6], in which
the polarization beam splitter unit selectively allows linearly polarized light or circularly polarized light to pass therethrough.

[8] The image display apparatus according to any one of [1] to [7], in which
the polarization beam splitter unit selectively allows linearly polarized light that is the image display light to pass therethrough, and
the polarization state converting unit converts a polarization state of the linearly polarized light into the polarization state to be reflected by the polarization beam splitter unit when reflecting the linearly polarized light that has passed through the polarization beam splitter unit.

[9] The image display apparatus according to [8], in which
the polarization beam splitter unit includes a wire grid or a multi-layer dielectric film.

[10] The image display apparatus according to [8] or [9], in which
the polarization state converting unit includes a wave plate.

[11] The image display apparatus according to [10], in which
a phase control reflection film is provided on a surface of two surfaces of the wave plate, which is on an air interface side.

[12] The image display apparatus according to any one of [1] to [7], in which
the polarization beam splitter unit has optical properties in that the polarization beam splitter unit selectively allows circularly polarized light that is the image display light to pass therethrough, and
the polarization state converting unit converts a polarization state of the circularly polarized light into the polarization state to be reflected by the polarization beam splitter unit when reflecting the circularly polarized light that has passed through the polarization beam splitter unit.

[13] The image display apparatus according to [12], in which
the polarization beam splitter unit includes a cholesteric liquid-crystal reflection element.

[14] The image display apparatus according to [12] or [13], in which
the second surface of the light guide plate converts a polarization state of the circularly polarized light that has passed through the polarization beam splitter unit into the polarization state to be reflected by the polarization beam splitter unit.

[15] The image display apparatus according to [13] or [14], in which
the polarization state converting unit includes a phase control reflection film.

[16] The image display apparatus according to [15], in which
the phase control reflection film is a silver coating.

[17] The image display apparatus according to any one of [1] to [16], in which
the image display apparatus further includes a scanning mirror, and
the scanning mirror scans the image display light and allows the image display light to travel inside the light guide plate.

[18] The image display apparatus according to any one of [1] to [17], in which
the image display apparatus is configured so that image display light emitted from the light guide plate is concentrated in vicinity of a pupil and reaches a retina.

[19] A light guide optical system, including:
a light guide plate;
a polarization beam splitter unit arranged on a first surface of the light guide plate; and
a polarization state converting unit arranged on a second surface of the light guide plate, in which
the polarization state converting unit reflects image display light that has passed through the polarization beam splitter unit and entered the light guide plate and converts a polarization state of the image display light into a polarization state to be reflected by the polarization beam splitter unit at the time of reflection.

### REFERENCE SIGNS LIST

1 image display apparatus
2 image formation unit
3 scanning mirror
4 collimator lens
100 light guide optical system
101 light guide plate
102 incidence unit
103 polarization beam splitter unit
104 polarization state converting unit
105 emission unit

What is claimed is:

1. An image display apparatus, comprising:
a light guide plate;
a polarization beam splitter unit arranged on a first surface of the light guide plate; and
a polarization state converting unit arranged on a second surface of the light guide plate, wherein
the polarization state converting unit reflects image display light that has passed through the polarization beam splitter unit and entered the light guide plate and converts a polarization state of the image display light into a polarization state to be reflected by the polarization beam splitter unit at the time of reflection.

2. The image display apparatus according to claim 1, wherein
the image display apparatus includes an incidence unit that allows the image display light to enter the light guide plate, and
the incidence unit reflects or transmits the image display light and allows the image display light to reach the polarization beam splitter unit.

3. The image display apparatus according to claim 2, wherein
the polarization beam splitter unit is arranged between the incidence unit and the light guide plate.

4. The image display apparatus according to claim 1, wherein
the image display apparatus includes an emission unit that reflects and diffracts or transmits and diffracts the image display light and allows the image display light to be emitted from the light guide plate.

5. The image display apparatus according to claim 4, wherein
the emission unit includes a hologram lens element.

6. The image display apparatus according to claim 4, wherein
the emission unit reflects and diffracts or transmits and diffracts the image display light so that the image display light concentrates.

7. The image display apparatus according to claim 1, wherein
the polarization beam splitter unit selectively allows linearly polarized light or circularly polarized light to pass therethrough.

8. The image display apparatus according to claim 1, wherein
the polarization beam splitter unit selectively allows linearly polarized light that is the image display light to pass therethrough, and
the polarization state converting unit converts a polarization state of the linearly polarized light into the polarization state to be reflected by the polarization beam splitter unit when reflecting the linearly polarized light that has passed through the polarization beam splitter unit.

9. The image display apparatus according to claim 8, wherein
the polarization beam splitter unit includes a wire grid or a multi-layer dielectric film.

10. The image display apparatus according to claim 8, wherein
the polarization state converting unit includes a wave plate.

11. The image display apparatus according to claim 10, wherein
a phase control reflection film is provided on a surface of two surfaces of the wave plate, which is on an air interface side.

12. The image display apparatus according to claim 1, wherein
the polarization beam splitter unit has optical properties in that the polarization beam splitter unit selectively allows circularly polarized light that is the image display light to pass therethrough, and
the polarization state converting unit converts a polarization state of the circularly polarized light into the polarization state to be reflected by the polarization beam splitter unit when reflecting the circularly polarized light that has passed through the polarization beam splitter unit.

13. The image display apparatus according to claim 12, wherein
the polarization beam splitter unit includes a cholesteric liquid-crystal reflection element.

14. The image display apparatus according to claim 12, wherein
the second surface of the light guide plate converts a polarization state of the circularly polarized light that has passed through the polarization beam splitter unit into the polarization state to be reflected by the polarization beam splitter unit.

15. The image display apparatus according to claim 13, wherein
the polarization state converting unit includes a phase control reflection film.

16. The image display apparatus according to claim 15, wherein
the phase control reflection film is a silver coating.

17. The image display apparatus according to claim 1, wherein
the image display apparatus further includes a scanning mirror, and
the scanning mirror scans the image display light and allows the image display light to travel inside the light guide plate.

18. The image display apparatus according to claim 1, wherein
the image display apparatus is configured so that image display light emitted from the light guide plate is concentrated in vicinity of a pupil and reaches a retina.

19. A light guide optical system, comprising:
a light guide plate;
a polarization beam splitter unit arranged on a first surface of the light guide plate; and
a polarization state converting unit arranged on a second surface of the light guide plate, wherein
the polarization state converting unit reflects image display light that has passed through the polarization beam splitter unit and entered the light guide plate and converts a polarization state of the image display light into a polarization state to be reflected by the polarization beam splitter unit at the time of reflection.
